(19) United States
(12) Patent Application Publication
(10) Pub. No.: US 2025/0383919 A1
(43) Pub. Date: Dec. 18, 2025

(54) STORAGE APPARATUS, RESOURCE ALLOCATION CONTROL METHOD, AND NON-TRANSITORY COMPUTER-READABLE STORAGE MEDIUM

(71) Applicant: Hitachi Vantara, Ltd., Yokohama-shi (JP)

(72) Inventors: Masahide KAWARASAKI, Yokohama-shi (JP); Tomohide HASEGAWA, Yokohama-shi (JP); Sachie TAJIMA, Yokohama-shi (JP)

(73) Assignee: Hitachi Vantara, Ltd., Yokohama-shi (JP)

(21) Appl. No.: 19/077,774

(22) Filed: Mar. 12, 2025

(30) Foreign Application Priority Data
Jun. 17, 2024 (JP) 2024-097337

(51) Int. Cl. G06F 9/50; G06F 11/34

(52) U.S. Cl. CPC G06F 9/5016; G06F 9/5055; G06F 11/3409

(57) ABSTRACT

A storage apparatus includes a plurality of pieces of software, and manages a plurality of pieces of allocation information defining allocation of cores for each group including at least one piece of software. The cores are allocated for each group based on any piece of allocation information. The plurality of pieces of allocation information are different in the number of cores allocated to a first group including first software for writing data to a storage device. The storage apparatus determines whether it is necessary to switch current allocation information based on operation rates of the cores allocated to the first group, switches the allocation information when it is necessary to switch the allocation information, and performs setting for permitting an interruption of an I/O process to the cores allocated to the first group.

### CLAIM OF PRIORITY

The present application claims priority from Japanese patent application JP 2024-097337 filed on Jun. 17, 2024, the content of which is hereby incorporated by reference into this application.

### BACKGROUND OF THE INVENTION

### 1. Field of the Invention

The present invention relates to resource allocation control of a storage apparatus.

### 2. Description of Related Art

Various types of software operate in a storage apparatus. Since resources of the storage apparatus are limited, it is important to allocate the resources to each piece of software so as to maximize processing performance. In response to this, a technique described in, for example, PTL 1 is known.

PTL 1 discloses that “a computer system includes a node including a processor and a memory, uses the processor and the memory as an arithmetic resource, includes an application program that operates using the arithmetic resource, and a storage control program that operates using the arithmetic resource for processing data input to and output from a storage apparatus by the application program, includes use resource amount information in which an operation state of the application program is associated with the arithmetic resource used by the application program and the storage control program, and changes allocation of the arithmetic resource to the application program and the storage control program used by the application program based on the operation state of the application program and the use resource amount information”.

### CITATION LIST

### Patent Literature

PTL 1: JP2022-056135A

### SUMMARY OF THE INVENTION

The technique in PTL 1 is a technique for controlling an amount of the resources in consideration of an operation state of software, and does not consider an operation state of the entire storage apparatus. The storage apparatus may be in a state in which there are many reading processes and a state in which there are many rewriting processes, and it is necessary to adjust the amount of the resources allocated to each piece of software according to each state.

A representative example of the invention disclosed in the present application is as follows. That is, a storage apparatus that provides a storage area to a host includes: a processor having a plurality of cores; a memory connected to the processor; a network interface connected to the processor; a plurality of storage devices connected to the processor; and a plurality of pieces of software, in which a plurality of pieces of allocation information defining allocation of the cores for each group including at least one piece of the software are managed, the cores are allocated for each group based on any piece of allocation information of the plurality of pieces of allocation information, the plurality of groups include a first group including first software for writing data to the plurality of storage devices, and the plurality of pieces of allocation information are different in the number of cores allocated to the first group. The processor acquires operation rates of the cores allocated to the first group, determines whether it is necessary to switch the current allocation information based on the operation rates of the cores allocated to the first group, switches the current allocation information to another allocation information when it is determined that it is necessary to switch the current allocation information, and performs setting for permitting an interruption of an I/O process to the cores allocated to the first group.

According to the invention, allocation of a core to software can be adjusted in accordance with an operation state of a storage apparatus. Problems, configurations, and effects other than those described above will be clarified by description of the following embodiment.

### BRIEF DESCRIPTION OF THE DRAWINGS

FIG. 1 is a diagram showing an example of a configuration of a storage system according to Embodiment 1;

FIG. 2 is a diagram showing an example of a functional configuration of a storage node according to Embodiment 1;

FIG. 3 is a diagram showing an example of operation information according to Embodiment 1;

FIG. 4A is a diagram showing an example of core allocation information according to Embodiment 1;

FIG. 4B is a diagram showing an example of the core allocation information according to Embodiment 1;

FIG. 4C is a diagram showing an example of the core allocation information according to Embodiment 1;

FIG. 4D is a diagram showing an example of the core allocation information according to Embodiment 1;

FIG. 5 is a diagram showing an example of transition control information according to Embodiment 1;

FIG. 6 is a flowchart showing an example of an operation state checking process executed by a core allocation unit according to Embodiment 1; and

FIG. 7 is a flowchart showing an example of a core allocation control process executed by the core allocation unit according to Embodiment 1.

### DESCRIPTION OF EMBODIMENTS

Hereinafter, an embodiment of the invention will be described with reference to the drawings. However, the invention is not to be construed as being limited to the description of the following embodiment. It will be easily understood by those skilled in the art that a specific configuration can be changed without departing from the spirit or scope of the invention.

In the following description, various types of information may be described by expressions such as “table”, “list” and “queue”, but the various types of information may be expressed by other data structures. In order to indicate that the information does not depend on the data structure, “XX table”, “XX list”, and the like may be referred to as “XX information”. When describing information contents, terms such as “identification information”, “identifier”, “name”, “ID”, and “number” are used, the terms can be replaced with one another. An “application”, an “app”, a “program”, and “software” have the same meaning.

In the configurations of the invention described below, the same or similar configurations or functions are denoted by the same reference signs, and a redundant description thereof will be omitted.

Notations “first”, “second”, “third”, and the like in the present specification and the like are provided to identify components, and do not necessarily limit the number or the order.

In order to facilitate understanding of the invention, a position, a size, a shape, a range, and the like of each configuration shown in the drawings and the like may not represent an actual position, size, shape, range, and the like. Therefore, the invention is not limited to the positions, sizes, shapes, ranges, and the like disclosed in the drawings and the like.

### Embodiment 1

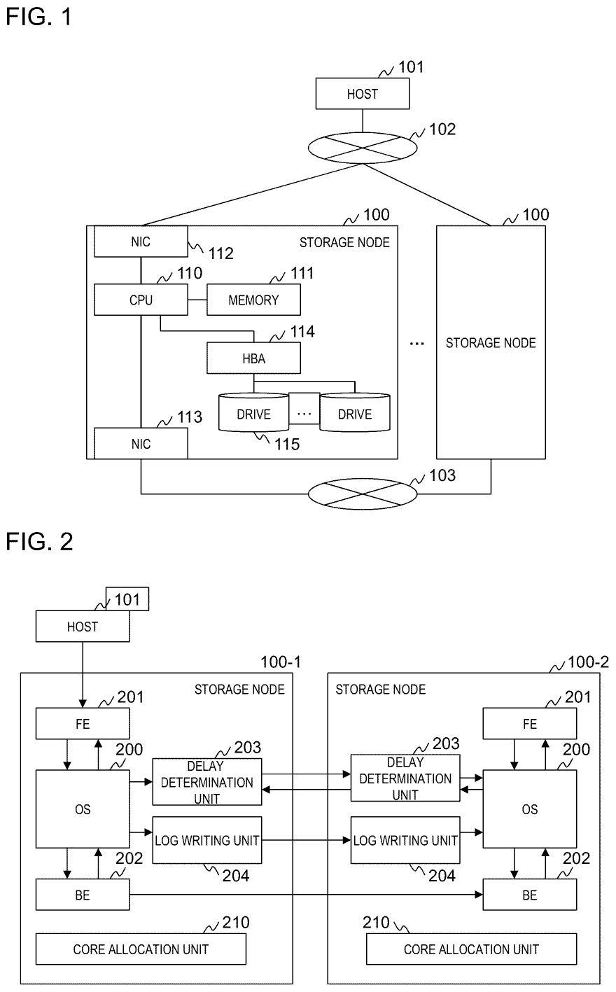

FIG. 1 is a diagram showing an example of a configuration of a storage system according to Embodiment 1.

The storage system includes a plurality of storage nodes 100. The storage nodes 100 are connected to one another via a backend network 103 such as a storage area network (SAN) or a local area network (LAN). The storage nodes 100 are connected to a host 101 that uses storage areas provided by the storage nodes 100 via a service network 102 such as the LAN.

The storage node 100 includes a central processing unit (CPU) 110, a memory 111, network interface cards (NICs) 112 and 113, a host bus adapter (HBA) 114, and a plurality of drives 115. The number of hardware elements is an example and is not limited thereto. For example, the storage node 100 may include two or more CPUs 110.

The CPU 110 is an arithmetic device that executes various processes of the storage node 100, and includes a plurality of cores. The memory 111 is a dynamic random access memory (DRAM) or the like, and stores programs and data. The memory 111 includes a cache area. The drive 115 is a non-volatile memory (NVMe) drive, a serial attached small computer system interface (SAS) drive, a serial advanced technology attachment (SATA), a solid state drive (SSD), or the like, and provides the storage area used by the host 101.

The NIC 112 is an interface for connecting to the service network 102. The NIC 113 is an interface for connecting to the backend network 103. The HBA 114 is an interface for connecting to the drive 115.

FIG. 2 is a diagram showing an example of a functional configuration of the storage node 100 according to Embodiment 1.

The storage node 100 includes, as software, an operating system (OS) 200, a front end (FE) 201, a back end (BE) 202, a delay determination unit 203, a log writing unit 204, and a core allocation unit 210.

The OS 200 controls the entire storage node 100. The OS 200 processes a host command transmitted by the host 101, and manages the storage area.

The FE 201 transmits the host command and various types of data to the host 101. For example, when receiving the host command, the FE 201 transmits the host command to the storage node 100 that provides the storage area as a target. The BE 202 writes data to the drives 115 of the plurality of storage nodes 100.

The delay determination unit 203 performs transmission and reception of the data and command received from the host 101 among the OSs 200 in the plurality of storage nodes 100 via the cache area. In addition to the function of the delay determination unit 203 described above, the log writing unit 204 writes update data stored in the cache area as a log in the drive 115 in the storage node 100 in which the log writing unit 204 operates.

The core allocation unit 210 controls allocation of cores to the OS 200, the FE 201, the BE 202, the delay determination unit 203, and the log writing unit 204. The core allocation unit 210 manages operation information 300, a plurality of pieces of core allocation information 400, and transition control information 500, which will be described later.

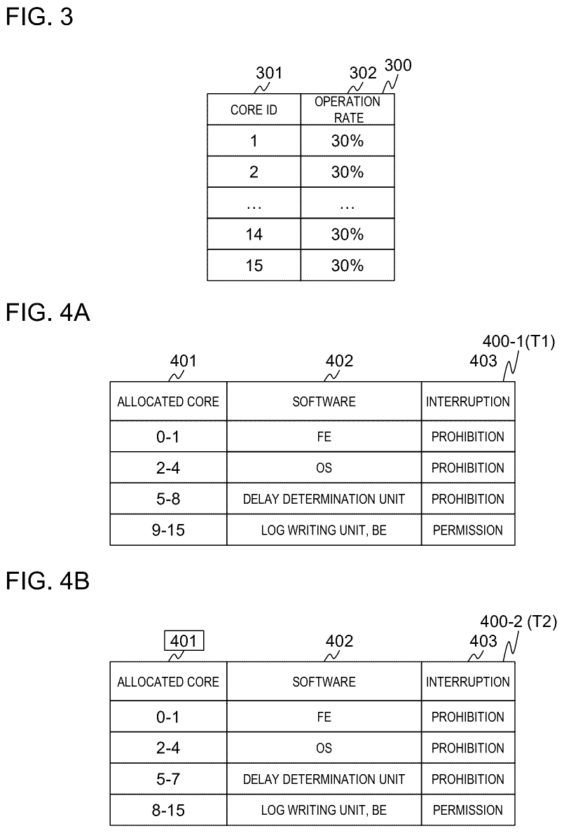

FIG. 3 is a diagram showing an example of the operation information 300 according to Embodiment 1.

The operation information 300 is information for monitoring an operation state of the core. The operation information 300 stores an entry including a core ID 301 and an operation rate 302.

The core ID 301 is a field for storing an ID of a core. The operation rate 302 is a field for storing an operation rate of a core.

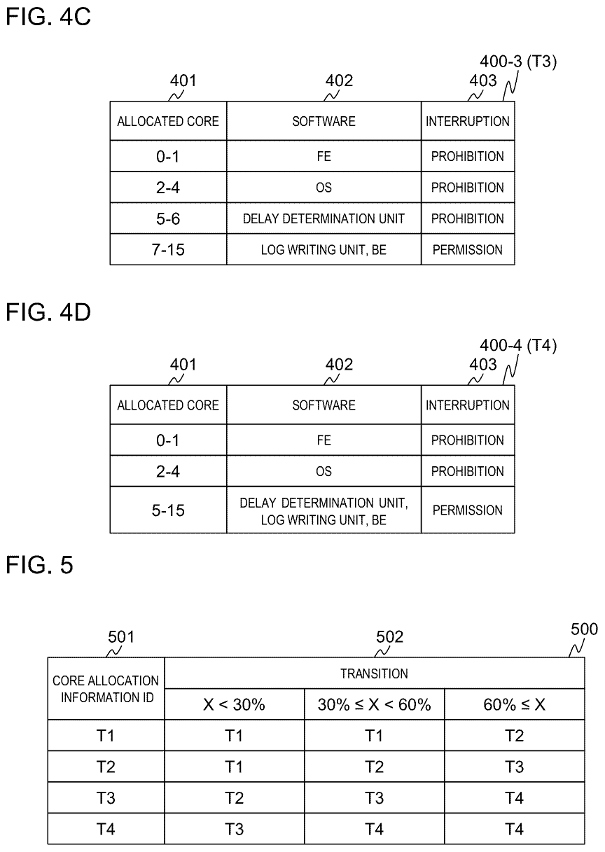

FIGS. 4A, 4B, 4C, and 4D are diagrams showing examples of the core allocation information 400 according to Embodiment 1. In the present embodiment, the core allocation unit 210 manages four pieces of core allocation information 400-1, 400-2, 400-3, and 400-4. In the present specification, IDs of the pieces of core allocation information 400-1, 400-2, 400-3, and 400-4 are T1, T2, T3, and T4, respectively.

The core allocation information 400 stores an entry including an allocation core 401, software 402, and an interruption 403. In the present embodiment, cores are allocated to each group including one or more pieces of software. In the core allocation information 400, one entry exists for one group.

The allocation core 401 is a field for storing IDs of cores allocated to a group. For example, “2-4” indicates that cores having IDs of 2, 3, and 4 are allocated. The software 402 is a field for storing a name of the software 402 constituting the group. The interruption 403 is a field for storing information indicating whether an interruption to the core is permitted.

The core allocation information 400-1 is core allocation that places importance on a response in a writing process. The core allocation information 400-4 is core allocation that places importance on a throughput in the writing process.

In the present embodiment, the core allocation information 400-1 is set when the storage node 100 is activated. The number of cores allocated to the group including the BE 202 in each piece of the core allocation information 400-2, 400-3, and 400-4 is larger than that in the core allocation information 400-1. The core allocation unit 210 switches the core allocation information 400 according to an operation state of the storage node 100.

The core allocation information 400-1 is the core allocation that places importance on the response, and the cores are exclusively allocated to the OS 200, the FE 201, and the delay determination unit 203. By exclusively allocating the cores to the FE 201, a response of a reading process can be improved. By exclusively allocating the cores to the delay determination unit 203, a response to the host 101 in a writing process can be improved. On the other hand, since the BE 202 and the log writing unit 204 share the cores, there is a possibility that processing waiting occurs when the writing process increases. On the other hand, the core allocation information 400-4 is core allocation that places importance on a throughput in the writing process. In the core allocation information 400-4, except for the cores exclusively allocated to the OS 200 or the FE 201, the remaining cores are shared by the delay determination unit 203 in addition to the BE 202 and the log writing unit 204.

The BE 202 is software for writing data to the drive 115 in association with the writing process. Therefore, when the operation rate of the core allocated to the group including the BE 202 is high, it can be estimated that there are many writing processes. In this case, the throughput of the writing process can be improved by increasing the number of cores allocated to the group including the BE 202.

Since a sudden change in the core allocation has a large influence, the core allocation is changed stepwise in the present embodiment.

FIG. 5 is a diagram showing an example of the transition control information 500 according to Embodiment 1.

The transition control information 500 stores an entry including a core allocation information ID 501 and a transition 502.

The core allocation information ID 501 is a field for storing the ID of the core allocation information 400. The transition 502 includes a field for storing the ID of the core allocation information 400 at a transition destination for each transition condition. The transition condition is expressed as a conditional expression using a determination index (X) described later.

The transition control information 500 stores data for implementing the following three types of control.
(1) Control for transitioning the core allocation information 400 so as to increase the cores allocated to the BE 202 along with an increase in the writing process
(2) Control for transitioning the core allocation information 400 so as to reduce the cores allocated to the BE 202 along with a decrease in the writing process
(3) Control for not switching the core allocation information 400

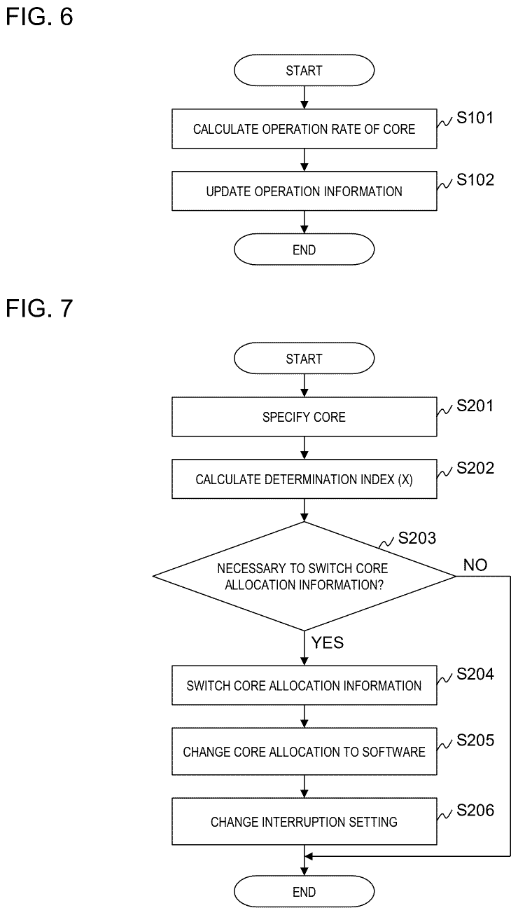

FIG. 6 is a flowchart showing an example of an operation state checking process executed by the core allocation unit 210 according to Embodiment 1. The core allocation unit 210 periodically executes the operation state checking process.

The core allocation unit 210 calculates an operation rate of a core (step S101). For example, when Linux (registered trademark) is used, the core allocation unit 210 refers to/proc/stat, and calculates the operation rate of the core.

The core allocation unit 210 updates the operation information 300 by reflecting the operation rate of the core in the operation information 300 (step S102).

FIG. 7 is a flowchart showing an example of a core allocation control process executed by the core allocation unit 210 according to Embodiment 1. The core allocation unit 210 periodically executes the core allocation control process.

The core allocation unit 210 refers to the set core allocation information 400, and specifies the core allocated to the group including the BE 202 (step S201).

The core allocation unit 210 acquires the operation rate of the specified core from the operation information 300, and calculates the determination index (X) based on the acquired operation rate (step S202). Specifically, the core allocation unit 210 calculates an average of the operation rates of the specified cores as the determination index (X).

The core allocation unit 210 refers to the transition control information 500 based on the set core allocation information 400 and the determination index (X), and determines whether it is necessary to switch the core allocation information 400 (step S203). For example, when the current core allocation information 400 is the core allocation information 400-1 and the determination index (X) is 70%, the core allocation unit 210 determines that it is necessary to switch the core allocation information 400. In this case, the core allocation unit 210 switches from the core allocation information 400-1 to the core allocation information 400-2 in step S204.

When it is not necessary to switch the core allocation information 400, the core allocation unit 210 ends the core allocation control process.

When it is necessary to switch the core allocation information 400, the core allocation unit 210 switches the core allocation information 400 based on the transition condition indicated by the transition 502 of the transition control information 500 (step S204).

The core allocation unit 210 changes the core allocation to each group based on the switched core allocation information 400 (step S205). For example, when Linux (registered trademark) is used, the core allocation is changed using group and taskset commands, or the like. Specifically, the core allocation unit 210 refers to the switched core allocation information 400, and sets ranges of cores allocated to the BE 202, the log writing unit 204, and the delay determination unit 203.

Based on the switched core allocation information 400, the core allocation unit 210 sets a core for executing an I/O interruption process (step S206), and then ends the core allocation control process. For example, when the core for executing the interruption process using an irqbalance service of Linux (registered trademark) is set, a setting file of the service is updated, and the irqbalance service is reactivated. Specifically, the core allocation unit 210 refers to the interruption 403 of the switched core allocation information 400, and sets a range of cores for which the I/O interruption is permitted.

As described above, according to the present embodiment, the storage node 100 can dynamically change the core allocated to the software according to the operation state of the storage node 100.

The invention is not limited to the embodiment described above, and includes various modifications. For example, the embodiment described above is described in detail to facilitate understanding of the invention, and the invention is not necessarily limited to those including all the described configurations. A part of a configuration in each embodiment may be added to, deleted from, or replaced with another configuration.

A part or all of the configurations, functions, processing units, processing methods, or the like described above may be implemented by hardware by, for example, designing with an integrated circuit. The invention can also be implemented by a program code of software for implementing functions of the embodiment. In this case, a storage medium recording the program code is provided to a computer, and a processor provided in the computer reads the program code stored in the storage medium. In this case, the program code itself read from the storage medium implements the functions of the embodiment described above, and the program code itself and the storage medium storing the program code implement the invention. Examples of the storage medium for providing such a program code include a flexible disk, a CD-ROM, a DVD-ROM, a hard disk, a solid state drive (SSD), an optical disk, a magneto-optical disk, a CD-R, a magnetic tape, a nonvolatile memory card, and a ROM.

Further, the program code for implementing the functions described in the present embodiment can be implemented in a wide range of programs or script languages such as Assembler, C/C++, Perl, Shell, PHP, Python, and Java (registered trademark).

Further, the program code of software for implementing the functions of the embodiment may be distributed via a network to be stored in a storage unit such as a hard disk or a memory of a computer or a storage medium such as a CD-RW or a CD-R, and a processor provided in the computer may read and execute the program code stored in the storage unit or the storage medium.

Control lines and information lines considered to be necessary for description are illustrated in the embodiment described above, and not all control lines and information lines in a product are necessarily shown. All the configurations may be connected.

What is claimed is:

1. A storage apparatus that provides a storage area to a host, comprising:
a processor having a plurality of cores;
a memory connected to the processor;
a network interface connected to the processor;
a plurality of storage devices connected to the processor; and
a plurality of pieces of software, wherein
a plurality of pieces of allocation information defining allocation of the cores for each group including at least one piece of the software are managed,
the cores are allocated for each group based on any piece of allocation information of the plurality of pieces of allocation information,
the plurality of groups include a first group including first software for writing data to the plurality of storage devices,
the plurality of pieces of allocation information are different in the number of cores allocated to the first group, and
the processor
acquires operation rates of the cores allocated to the first group,
determines whether switching of the current allocation information based on the operation rates of the cores allocated to the first group is necessary,
switches the current allocation information to another allocation information when a determination is made that switching of the current allocation information is necessary, and
performs setting for permitting an interruption of an I/O process to the cores allocated to the first group.

2. The storage apparatus according to claim 1, wherein
the storage apparatus is connected to another storage apparatus via a network,
the plurality of pieces of software include second software that transmits and receives data and a command received from the host to and from the memory of the another storage apparatus, and
the plurality of pieces of allocation information include allocation information that defines allocation of the cores to the first group, a second group including the second software, and the group other than the first group and the second group, and allocation information that defines allocation of the cores to the first group including the second software and the group other than the first group.

3. The storage apparatus according to claim 2, wherein
the storage apparatus holds transition control information for managing association between the current allocation information, a conditional expression defined by an operation index and a threshold calculated from the operation rates of the cores allocated to the first group, and the allocation information at a switching destination, and
the processor
calculates the operation index from the operation rates of the cores allocated to the first group,
refers to the transition control information based on the operation index, and determines whether switching of the current allocation information is necessary.

4. The storage apparatus according to claim 2, wherein
the first group includes software that is stored in the memory and writes data received from the host to the storage device as a log.

5. The storage apparatus according to claim 2, wherein
the plurality of pieces of allocation information include allocation information in which the cores are exclusively allocated to the group other than the first group.

6. The storage apparatus according to claim 5, wherein
the plurality of pieces of allocation information include allocation information in which the cores are allocated to the first group and the second group in a shared manner.

7. A resource allocation control method executed by a storage apparatus that provides a storage area to a host, wherein the storage apparatus includes
a processor having a plurality of cores,
a memory connected to the processor,
a network interface connected to the processor,
a plurality of storage devices connected to the processor, and
a plurality of pieces of software,
a plurality of pieces of allocation information defining allocation of the cores for each group including at least one piece of the software are managed,
the cores are allocated for each group based on any piece of allocation information of the plurality of pieces of allocation information,
the plurality of groups include a first group including first software for writing data to the plurality of storage devices, and
the plurality of pieces of allocation information are different in the number of cores allocated to the first group,
the resource allocation control method comprising:
a step of the processor acquiring operation rates of the cores allocated to the first group;
a step of the processor determining whether switching of the current allocation information based on the operation rates of the cores allocated to the first group is necessary;
a step of the processor switching the current allocation information to another allocation information when a determination is made that switching of the current allocation information is necessary; and
a step of the processor performing setting for permitting an interruption of an I/O process to the cores allocated to the first group.

8. A non-transitory computer-readable storage medium storing a program for causing a storage apparatus that provides a storage area to a host, wherein the storage apparatus includes
a processor having a plurality of cores,
a memory connected to the processor,
a network interface connected to the processor,
a plurality of storage devices connected to the processor, and
a plurality of pieces of software,
a plurality of pieces of allocation information defining allocation of the cores for each group including at least one piece of the software are managed,
the cores are allocated for each group based on any piece of allocation information of the plurality of pieces of allocation information,
the plurality of groups include a first group including first software for writing data to the plurality of storage devices, and
the plurality of pieces of allocation information are different in the number of cores allocated to the first group,
the program causing the processor to execute:
a procedure of acquiring operation rates of the cores allocated to the first group;
a procedure of determining whether switching of the current allocation information based on the operation rates of the cores allocated to the first group is necessary;
a procedure of switching the current allocation information to the another allocation information when a determination is made that switching of the current allocation information is necessary; and
a procedure of performing setting for permitting an interruption of an I/O process to the cores allocated to the first group.
